(19) United States
(12) Patent Application Publication
(10) Pub. No.: US 2026/0151828 A1
(43) Pub. Date: Jun. 4, 2026

(54) ARTICLES COMPRISING ALLOY COMPOUND FOR CONTAINMENT OF MOLTEN MATERIALS AND METHODS OF MAKING THE SAME

(71) Applicant: Battelle Energy Alliance, LLC, Idaho Falls, ID (US)

(72) Inventors: Prabhat K. Tripathy, Idaho Falls, ID (US); Kenneth C. Marsden, Idaho Falls, ID (US); James A. King, Idaho Falls, ID (US); David D. Tolman, Idaho Falls, ID (US); Kevin R. Tolman, Idaho Falls, ID (US)

(21) Appl. No.: 19/406,696

(22) Filed: Dec. 2, 2025

Related U.S. Application Data
(60) Provisional application No. 63/727,372, filed on Dec. 3, 2024.

(51) Int. Cl. B22D 41/02; C01B 21/082; C09D 1/00; C09D 5/18; C09D 7/80

(52) U.S. Cl. CPC B22D 41/02; C01B 21/0828; C09D 1/00; C09D 5/18; C09D 7/80; C01P 2006/37

(57) ABSTRACT

An article for containing a molten material is disclosed. The article comprises an alloy compound. The alloy compound includes a transition metal and three non-metallic elements distributed within the transition metal. The transition metal is chosen from a group IVB element, a group VB element, or a group VIB element. The non-metallic elements are independently chosen from carbon, nitrogen, oxygen, silicon, boron, or phosphorus. A method of producing an article comprises forming a carboxynitride compound of a transition metal chosen from a group IVB element, a group VB element, or a group VIB element; and forming the article comprising the carboxynitride compound of the transition metal.

### CROSS-REFERENCE TO RELATED APPLICATIONS

This application claims the benefit under 35 U.S.C. § 119 (e) of U.S. Provisional Patent Application Ser. No. 63/727,372, filed Dec. 3, 2024, the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

Embodiments of the disclosure relate generally to articles for containing and handling molten materials. More specifically, embodiments relate to articles comprising an alloy compound that can be used to contain and handle molten metals, molten metal salts, molten slags, molten metal alloys, or a combination thereof.

### BACKGROUND

Problems exist in the handling and containment of highly reactive molten materials such as molten metals, molten metal salts, molten slags, and molten metal alloys in a suitable crucible material. For example, most metals display a higher degree of reactivity when they are in molten states. Particular problems relate to the crucible (i.e., vessel) that are used to contain highly reactive molten materials during melt processing and/or fabrication of finished components. Ideally, crucibles should be resistant to thermal and physical shocks and exhibit chemical resistance to the highly reactive molten materials. Besides, large-scale manufacturing of these crucibles should be achieved at an acceptable manufacturing cost.

Ceramic and/or refractory-lined graphite crucibles are commonly used to contain reactive molten materials, such as metals with high temperature melting points and their compounds/alloys. Ceramic crucibles, when subjected to thermal cycling, often fail because of the formation of cracks on their surfaces. Unlike ceramic containers, graphite crucibles possess excellent thermal conductivity and as a result are less likely to fail by cracking. However, when uncoated and/or in the absence of unreactive inner lining materials, graphite may not exhibit better chemical inertness, particularly in the presence of molten materials. For example, graphite may react with molten metals, such as uranium, titanium, vanadium, niobium molten uranium (forming respective metal carbides) and thereby resulting in its degradation. For example, a titanium-based alloy, such as titanium aluminide, may dissolve large quantities of carbon from the graphite crucible into the titanium-based alloys, resulting in contamination that jeopardizes the mechanical properties of the alloys. Therefore, not only does the graphite crucible physically deteriorate with time (and eventually becomes unusable), but also the resulting molten material becomes contaminated and hence chemically less pure. It is this latter problem that is particularly important when the molten materials must be of very high purity for certain applications, such as the fabrication of nuclear-grade components/materials.

### SUMMARY

In the first aspect, an article for containing a molten material is disclosed. The article comprises an alloy compound. The alloy compound comprises a transition metal and three non-metallic elements distributed within the transition metal. The transition metal is chosen from a group IVB element, a group VB element, or a group VIB element. The non-metallic elements are independently chosen from carbon, nitrogen, oxygen, silicon, boron, or phosphorus.

In the second aspect, an article for containing a molten material is disclosed. The article comprises a crucible, and an alloy coating having a first surface adjacent an inner surface of the crucible and a second surface opposite the first surface. The second surface of the alloy coating defines an exposed interior surface of the article. The alloy coating comprises a carboxynitride compound of a transition metal chosen from a group IVB element, a group VB element, or a group VIB element.

In the third aspect, a method of producing an article configured to contain a molten material is disclosed. The method includes forming a carboxynitride compound of a transition metal chosen from a group IVB element, a group VB element, or a group VIB element. Forming the carboxynitride compound includes preparing a mixture comprising at least one oxide of the transition metal, at least one nitride of the transition metal, and at least one source of carbon. The mixture is covered with a salt composition comprising a salt of an alkaline metal, a salt of an alkaline earth metal, or a combination thereof. The mixture and the salt composition are heated at a temperature of less than about 1000° C. under an inert atmosphere to produce a product comprising a solidified salt and the carboxynitride compound of the transition metal. The carboxynitride compound of the transition metal is separated from the solidified salt. The method further includes forming the article comprising the carboxynitride compound of the transition metal.

### BRIEF DESCRIPTION OF THE DRAWINGS

FIG. 1 is a photograph showing porous pellets of vanadium carboxynitride product #4; and

FIG. 2 is a photograph showing the porous pellets of vanadium carboxynitride product #4 after arc-melting and being mounted on an araldite mold.

### DETAILED DESCRIPTION

Embodiments described herein generally relate to articles for containing and handling reactive materials, such as molten metals, molten metal salts, molten slags, or molten metal alloys, and methods for producing such articles. The disclosed articles may exhibit an improved inertness toward chemical reaction with the highly reactive molten materials (e.g., metals, metal salts molten slags, or metal alloys), an enhanced resistance to thermal and physical shock, and an extended usable life of the fabricated article as compared to conventionally used articles.

In the following detailed description, reference is made to the accompanying drawings, which form a part hereof, and in which are shown, by way of illustration, specific example embodiments in which the disclosure may be practiced. These embodiments are described in sufficient detail to enable a person of ordinary skill in the art to practice the disclosure. However, other embodiments may be utilized, and structural, material, and process changes may be made without departing from the scope of the disclosure. Thus, the following description of various embodiments is not intended to limit the scope of the disclosure but is merely representative of various embodiments.

As used herein, the singular forms following “a,” “an,” and “the” are intended to include the plural forms as well, unless the context clearly indicates otherwise.

As used herein, “and/or” includes any and all combinations of one or more of the associated listed items.

As used herein, the term “about” used in reference to a numerical value for a particular parameter is inclusive of the numerical value and a degree of variance from the numerical value that one of ordinary skill in the art would understand is within acceptable tolerances for the particular parameter. For example, “about” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “comprise(s),” “comprising,” “include(s),” “including,” “having,” “has,” “contain(s),” “containing,” and variants thereof, are open-ended transitional phrases, terms, or words that are meant to encompass the items listed thereafter and equivalents thereof as well as additional items.

As used herein, “molten material” means and includes a molten metal, a molten metal salt, a molten metal alloy, a molten slag, or a combination thereof.

As used herein, “room temperature” means and includes a temperature range of from about 20° C. to about 22° C.

An article of embodiments of the disclosure is suitable for containing a molten material. The disclosed article is formed of and includes an alloy compound. The alloy compound comprises a transition metal, and three non-metallic elements distributed within the crystal lattice of the transition metal. The transitional metal is chosen from a group IVB element, a group VB element, or a group VIB element. The non-metallic elements are independently chosen from carbon, nitrogen, oxygen, silicon, boron, or phosphorus. With three non-metallic elements, the alloy compound becomes a quaternary alloy.

As used herein, the term “group IVB element” is as defined by the CAS (Chemical Abstract Service) group number, which means and includes titanium (Ti), zirconium (Zr), and hafnium (Hf).

As used herein, the term “group VB element” is as defined by the CAS group number, which means and includes vanadium (V), niobium (Nb), and tantalum (Ta).

As used herein, the term “group VIB element” is as defined by the CAS group number, which means and includes chromium (Cr), molybdenum (Mo), and tungsten (W).

In some embodiments, the non-metallic elements are independently chosen from carbon, oxygen, nitrogen, silicon, phosphorous, or boron.

In some embodiments, the alloy compound comprises a carboxynitride compound of the transition metal chosen from the group IVB elements, the group VB elements, or the group VIB elements.

In some embodiments, the alloy compound comprises a carboxynitride compound of the transition metal chosen from titanium (Ti), zirconium (Zr), hafnium (Hf), vanadium (V), niobium (Nb), tantalum (Ta), chromium (Cr), molybdenum (Mo), or tungsten (W).

In some embodiments, the alloy compound comprises a carboxynitride compound of the transition metal chosen from titanium (Ti), zirconium (Zr), hafnium (Hf), vanadium (V), niobium (Nb), or tantalum (Ta).

A method of producing an article comprises forming the alloy compound and forming the article comprising the alloy compound.

In some embodiments, the alloy compound is formed into an article for containing and handling molten metals, molten metal salts, molten slags, or molten metal alloys. The alloy compound may be configured into a desired size and shape of the article. The article may be configured as a monolithic article formed from and including the alloy compound.

In some embodiments, the alloy compound is used as a coating for a crucible (e.g., substrate) to form an article for containing and handling molten metals, molten metal salts, molten slags, or molten metal alloys. Thus, the article may comprise a crucible (e.g., a substrate) and a coating comprising the disclosed alloy compound on the crucible. The coating has a first surface adjacent an inner surface of the crucible and a second surface opposite the first surface, wherein the second surface of the coating defines an exposed interior surface of the article. Multiple coatings of the alloy compound may be formed on the crucible. In some embodiments, the crucible is formed of and includes a high-density graphite.

A method of producing an article may comprise forming a carboxynitride compound of a transition metal chosen from a group IVB element, a group VB element, or a group VIB element, and forming the article comprising the carboxynitride compound.

The carboxynitride compound may be produced by preparing a mixture comprising at least one oxide of the transition metal, at least one nitride of the transition metal, and at least one source of carbon. In some embodiments, the source of carbon includes graphite or a powdered carbon. In some embodiments, the source of carbon includes metal carbide. The mixture may, for example, include a binary oxide of the transition metal, a binary nitride of the transition metal, and graphite.

In some embodiments, the oxide of the transition metal, the nitride of the transition metal, and the source of carbon are individually in a form of powder. The particle size of the oxide of the transition metal may be in a range of from about 10 μm to about 45 μm. The particle size of the nitride of the transition metal may be in a range of from about 10 μm to about 45 μm. The particle size of the source of carbon (e.g., graphite powder) may be in a range of from about 10 μm to about 20 μm.

In some embodiments, a mixture of at least one oxide of the transition metal, at least one nitride of the transition metal, and at least one source of carbon is prepared by combining the powder of at least one oxide of the transition metal, the powder of at least one nitride of the transition metal, and the powder of at least one source of carbon together, and then milling (e.g., ball milling) the mixture to provide a powder mixture. The powder mixture may be used directly for an annealing process, or the powder mixture may be pelletized into pellets prior to an annealing process. Furthermore, the powder mixture may be pelletized into pellets, and then the pellets are heat treated at a temperature below an annealing temperature to impart sufficient mechanical strength to the pellets, before subjecting the pellets to an annealing process. As a non-limiting example, the pellets may be heat treated at a temperature of about 500° C. under an inert atmosphere before conducting an annealing process at a temperature of about 950° C.

The mixture of at least one oxide of the transition metal, at least one nitride of the transition metal, and at least one source of carbon is then placed in a container, and covered (e.g., completely covered) with salt. The salt may comprise a salt of an alkaline metal, a salt of an alkaline earth metal, or a combination thereof. For example, the salt may comprise lithium chloride (LiCl), sodium chloride (NaCl), potassium chloride (KCl), cesium chloride (CsCl), calcium chloride (CaCl₂)), lithium bromide (LiBr), sodium bromide (NaBr), potassium bromide (KBr), cesium bromide (CsBr), calcium bromide (CaBr₂), or a combination thereof. In some embodiments, the salt comprises LiCl. In some embodiments, the salt comprises KBr. In some embodiments, the salt comprises CaCl₂). In some embodiments, the salt comprises a mixture of NaCl and KCl. In some embodiments, the salt comprises a mixture of NaBr and KBr. In some embodiments, the salt comprises a mixture of NaCl and CaCl₂). In some embodiments, the salt comprises a mixture of LiCl, NaCl, and KCl. In some embodiments, the salt comprises a mixture of LiCl, KCl, and CsCl. In some embodiments, the salt comprises a mixture of LiBr, NaBr, and KBr. In some embodiments, the salt comprises a mixture of LiBr, KBr, and CsBr. In some embodiments, the salt comprises a mixture of LiCl, NaCl, KCl, and CaCl₂).

The mixture and the salt in the container are heated (e.g., annealed) at a temperature of less than about 1000° C. under an inert atmosphere (e.g., argon atmosphere). The heating melts the salt and produces a product. In some embodiments, the annealing process is performed at a temperature of at least about 500° C. but less than about 1000° C. In some embodiments, the annealing process is performed under an inert atmosphere at a temperature of from about 500° C. to about 975° C. The annealing process may be performed for up to about 24 hours.

After the annealing process, the product is cooled down to room temperature. The product comprises a carboxynitride compound of the transition metal, and a solidified salt. The carboxynitride compound of the transition metal may be separated from the solidified salt by washing the product with water to dissolve away the salt. The carboxynitride compound of the transition metal may exhibit increased mechanical strength and hardness, in addition to chemical inertness and high temperature durability. The carboxynitride compound of the transition metal may include atoms of the non-metallic elements in the spaces (e.g., interstices) in a crystal lattice structure of the transition metal, producing an interstitial alloy of the transition metal and the non-metallic elements.

The recovered carboxynitride compound of the transition metal may be used for the formation of an article, e.g., the article for containing a molten material, such as a monolithic article. Since the carboxynitride compound of the transition metal is produced by relatively simple acts, such as combining the starting materials and heating the resulting mixture in the presence of a salt, the overall cost of the process is low. In some embodiments, the carboxynitride compound of the transition metal is formed into a crucible (e.g., substrate). In some embodiments, the carboxynitride compound of the transition metal is formulated, either alone or in combination with other compounds, into a coating for coating the crucible (e.g., substrate). The crucible may be coated with one or more layers of the coating comprising the disclosed carboxynitride compound of the transition metal. Furthermore, the crucible may be coated with other functional coating(s), before and/or after the crucible is coated with one or more layers of the coating comprising the carboxynitride compound of the transition metal.

In some embodiments, the disclosed article is suitable for use in melting a titanium-based alloy (e.g., titanium aluminide alloy), which is generally performed at a temperature of from about 1370° C. to about 1700° C. In some embodiments, the disclosed article is suitable for containing, processing and/or casting of molten copper. The molten copper is typically maintained at a temperature of about 1125° C.

Although the article is described herein as a crucible (i.e., a vessel) for containing molten materials, the disclosure is not limited. The article may be used as a component of a device that is in direct contact with the molten material. As non-limiting examples, the article may be a component (e.g., in the form of a plate or a baffle) of a collector for collecting the molten material, a die used for producing products made from the molten material, a sensor for determining an amount of a dissolved gas in the molten material, or an ultrasonic device for reducing gas content (e.g., hydrogen) in the molten material. The article may also be used in other extreme environments, such as high temperature environments, oxidizing and reducing environments, ionizing radiation environments, elevated pressure environments, and/or vacuum environments.

The disclosed article may exhibit an enhanced thermal and physical stability at an elevated temperature, as well as an improved degree of chemical inertness, which minimizes the chemical and mechanical degradation of the article while in contact with the molten materials (e.g., molten uranium, molten titanium alloy). The chemical and mechanical stability of the article enable long term containment of reactive materials, such as molten materials. Furthermore, the disclosed article may be produced at a relatively lower cost, such as through an electroplating and a subsequent annealing process, compared to the cost of conventional articles.

Moreover, when a highly reactive material (e.g., metal, metal salt, or metal alloy) is melted in the article, the resulting molten material may contain relatively fewer contaminants compared to the molten material prepared in the conventional article (e.g., graphite crucible without the disclosed coating). In some embodiments, the article may be used to contain the molten material at a temperature of up to about 1700° C.

Furthermore, the disclosed method of producing the carboxynitride compound of the transition metal may be achieved at a lower temperature (e.g., at a temperature of less than about 1000° C.), compared to the conventional methods of producing metal carboxynitride of the transition metal that typically require heating to a temperature above 1000° C. For example, the conventional preparation of a metal carboxynitride (e.g., titanium carboxynitride) by carbothermic reduction of a metal oxide in the presence of nitrogen gas is performed at a temperature above 1200° C. The conventional preparation of a metal carboxynitride (e.g., vanadium carboxynitride) by carbonitrothermic reduction of a metal oxide is performed at a temperature of about 1500° C. The conventional preparation of a metal carboxynitride (e.g., titanium-zirconium carboxynitride) by a spark plasma sintering process is performed at a temperature of about 2000° C.

The following examples serve to explain embodiments of the disclosure in more detail. These examples are not to be construed as being exhaustive, exclusive, or otherwise limiting as to the scope of the disclosure.

### Examples

Vanadium pentoxide (V₂O₅, at 99% purity), and/or vanadium trioxide (V₂O₃) was used as an oxide of vanadium (a transition metal in group VB according to the CAS group number). The oxide of vanadium had an average particle size in a range of from about 37 microns (μm) to about 44 μm. Graphite powder, at 99.5% purity, was used as a source for carbon. The graphite powder had an average particle size in a range of from about 37 μm to about 44 μm. Vanadium nitride (VN) powder, at 99% purity and having an average particle size of from about 10 μm to about 20 μm, was used as a nitride of vanadium (V). About 5% camphor in acetone was used as a binder. Sodium bromide (NaBr, anhydrous grade, 99.5% purity) and potassium bromide (KBr, anhydrous grade, 99.5% purity) were used as the salts.

Calculated quantities of vanadium pentoxide (V₂O₅) powder, graphite powder, and vanadium nitride (VN) powder were thoroughly homogenized in an agate pestle and mortar. To the powder mixture, isopropanol was added to make a slurry. The slurry was ball-milled, in an alumina ball miller, for 12 hours. To the ball-milled powder, a few drops (e.g., 4 drops to 5 drops) of 5% camphor in acetone was added. The mixed powder was subsequently pelletized into pellets having an average diameter in a range of from about 10 mm to about 15 mm to provide green pellets. The green pellets were subsequently heat-treated at a temperature of about 500° C. in an inert environment (inside the argon atmosphere glove box) for 5 hours to impart adequate mechanical strength.

The heat-treated (e.g., lightly sintered) pellets were kept in an alumina crucible. The crucible was then filled with from about 200 g to about 250 g of an equimolar NaBr and KBr salt mixture, covering the entire body of the sintered pellets. A lid was placed on top of the crucible before it was placed in a furnace, located in the argon atmosphere glove box.

The lightly sintered pellets and the salt mixture in the alumina crucible were annealed by placing the alumina crucible in a furnace and setting the furnace to heat at a rate of 50° C./min. The annealing process was performed at different temperatures and different time periods to investigate the effect of annealing temperature and time on the chemical compositions of vanadium carboxynitride product.

After the annealing process, the product was cooled to room temperature and washed with water to isolate vanadium carboxynitride product from the solidified NaBr and KBr salt mixture. The recovered vanadium carboxynitride product was subjected to an elemental analysis to determine the chemical composition therein. TABLE 1 shows the elemental analysis of the vanadium carboxynitride products obtained from the annealing process at different annealing temperatures and times.

TABLE 1

| Vanadium | Annealing Conditions | | Elemental Analysis | | |
|---|---|---|---|---|---|
| Carboxynitride | Temperature | Time | (% by weight) | | |
| Product | (° C.) | (hours) | Carbon | Oxygen | Nitrogen |
| #1 | 700 | 5 | 15.0 | 20.0 | 10.0 |
| #2 | 800 | 20 | 7.5 | 9.0 | 8.0 |
| #3 | 850 | 15 | 7.0 | 8.5 | 7.5 |
| #4 | 950 | 24 | 6.1 | 8.2 | 7.2 |

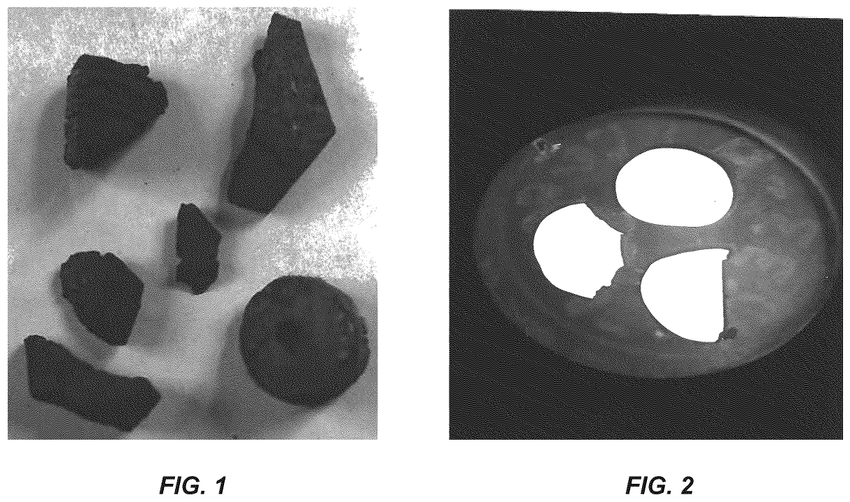

The vanadium carboxynitride product #4 was obtained by annealing the sintered pellets and the salt mixture in the alumina crucible at a temperature of about 950° C. for about 24 hours. The elemental analysis showed that the chemical compositions of the vanadium carboxynitride product #4 corresponded to V₃(C₁N₁O₁) stoichiometry. FIG. 1 is a photograph of the vanadium carboxynitride product #4 in the form of porous pellets/chunks.

During the annealing process, graphite (a carbon source) reacted with vanadium oxide (V₂O₅) to form vanadium oxycarbide [V(C,O)], which subsequently reacted with vanadium nitride (VN) to provide the vanadium carboxynitride product. The formation of the vanadium carboxynitride product was believed to have taken place by the following sequence of chemical reactions:

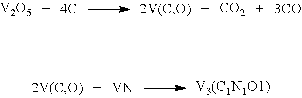

The porous pellets of the vanadium carboxynitride product #4 were then consolidated into buttons by arc-melting prior to placing them in contact with molten materials. FIG. 2 is a photograph of the arc-melted porous pellets of the vanadium carboxynitride product #4, mounted on an araldite mold.

The arc-melted buttons were then tested for stability (e.g., reactivity) with molten aluminum. An averaged weight of the arc-melted buttons prior to the stability testing was about 5.5 g. The arc-melted buttons were immersed in molten aluminum at a temperature of about 700° C. for about 5 hours. Then, the arc-melted buttons were removed from the molten aluminum, cooled to room temperature, washed with water, and dried. The averaged weight of the arc-melted buttons after the stability testing was about 5.4 g. This indicated that the vanadium carboxynitride product #4, which had V₃(C₁N₁O1) stoichiometry, was stable when placed in contact with molten aluminum.

While the invention is susceptible to various modifications and alternative forms, specific embodiments have been shown by way of example in the drawings and have been described in detail herein. However, the invention is not intended to be limited to the particular forms disclosed. Rather, the invention is to cover all modifications, equivalents, and alternatives falling within the scope of the invention as defined by the following appended claims and their legal equivalents.

What is claimed is:

1. An article for containing a molten material, comprising:
an alloy compound comprising:
a transition metal chosen from a group IVB element, a group VB element, or a group VIB element; and
three non-metallic elements distributed within the transition metal, the three non-metallic elements independently chosen from carbon, nitrogen, oxygen, silicon, boron, or phosphorus.

2. The article of claim 1, wherein the three non-metallic elements are chosen from carbon, nitrogen, oxygen, or boron.

3. The article of claim 1, wherein the alloy compound comprises a carboxynitride compound of the transition metal.

4. The article of claim 1, wherein the alloy compound comprises a carboxynitride compound of the transition metal chosen from titanium (Ti), zirconium (Zr), hafnium (Hf), vanadium (V), niobium (Nb), tantalum (Ta), chromium (Cr), molybdenum (Mo), or tungsten (W).

5. An article for containing a molten material, comprising:
a crucible; and
an alloy coating having a first surface adjacent an inner surface of the crucible and a second surface opposite the first surface, the second surface of the alloy coating defining an exposed interior surface of the article, the alloy coating comprising a carboxynitride compound of a transition metal chosen from a group IVB element, a group VB element, or a group VIB element.

6. The article of claim 5, wherein the crucible comprises a high-density graphite.

7. The article of claim 5, wherein the alloy coating comprises a carboxynitride compound of titanium (Ti), zirconium (Zr), hafnium (Hf), vanadium (V), niobium (Nb), or tantalum (Ta).

8. The article of claim 5, wherein the article comprises one or more layers of the alloy coating.

9. A method of producing an article, comprising:
forming a carboxynitride compound of a transition metal chosen from a group IVB element, a group VB element, or a group VIB element, forming the carboxynitride compound comprising:
preparing a mixture comprising at least one oxide of the transition metal, at least one nitride of the transition metal, and at least one source of carbon;
covering the mixture with a salt composition comprising a salt of an alkaline metal, a salt of an alkaline earth metal, or a combination thereof;
heating the mixture and the salt composition at a temperature of less than about 1000° C. under an inert atmosphere to produce a product comprising a solidified salt and the carboxynitride compound of the transition metal;
separating the carboxynitride compound of the transition metal from the solidified salt; and
forming the article from the carboxynitride compound of the transition metal, the article configured to contain a molten material.

10. The method of claim 9, wherein preparing the mixture comprises combining the at least one oxide of the transition metal and the at least one nitride of the transition metal with a graphite or a carbon powder.

11. The method of claim 9, wherein preparing the mixture comprises combining the at least one oxide of the transition metal and the at least one nitride of the transition metal with a metal carbide.

12. The method of claim 9, wherein preparing the mixture comprises combining a binary oxide of the transition metal, a binary nitride of the transition metal, and graphite.

13. The method of claim 9, wherein preparing the mixture comprises:
combining a powder of the at least one oxide of the transition metal, a powder of the at least one nitride of the transition metal, and a powder of the at least one source of carbon to produce the mixture; and
milling the mixture into a powder mixture.

14. The method of claim 13, wherein preparing the mixture further comprises pelletizing the powder mixture to produce the mixture in a pellet form.

15. The method of claim 14, wherein heating the mixture and the salt composition under the inert atmosphere comprises:
heating the mixture in the pellet form at a first temperature to enhance a mechanical strength of the pellets; and
annealing the heat-treated pellets at a second temperature higher than the first temperature and less than about 1000° C.

16. The method of claim 9, wherein heating the mixture and the salt composition under the inert atmosphere comprises annealing the mixture at a temperature of from at least about 500° C. to less than about 1000° C.

17. The method of claim 9, wherein covering the mixture with the salt composition comprises covering the mixture with a salt composition comprising lithium chloride (LiCl), sodium chloride (NaCl), potassium chloride (KCl), cesium chloride (CsCl), calcium chloride (CaCl₂)), lithium bromide (LiBr), sodium bromide (NaBr), potassium bromide (KBr), cesium bromide (CsBr), calcium bromide (CaBr₂), or a combination thereof.

18. The method of claim 9, wherein the covering the mixture with the salt composition comprises covering the mixture with a salt composition consisting of an equimolar sodium bromide (NaBr) and potassium bromide (KBr).

19. The method of claim 9, wherein separating the carboxynitride compound of the transition metal from the solidified salt comprises washing the product with water.

20. The method of claim 9, wherein forming the article comprises coating a crucible with the carboxynitride compound of the transition metal.
